(19) United States
(12) Patent Application Publication
(10) Pub. No.: US 2016/0191445 A1
(43) Pub. Date: Jun. 30, 2016

(54) SYSTEM AND METHOD FOR SENDING MESSAGES TO A PLURALITY OF RECIPIENTS

(71) Applicant: Unify GmbH & Co. KG, Munchen (DE)

(72) Inventor: Thomas Lederer, Herrsching (DE)

(21) Appl. No.: 15/066,216

(22) Filed: Mar. 10, 2016

Related U.S. Application Data
(63) Continuation of application No. 12/367,054, filed on Feb. 6, 2009.

(51) Int. Cl. H04L 12/58; H04L 29/12

(52) U.S. Cl. CPC H04L 51/28; H04L 61/1564; H04L 61/1594

(57) ABSTRACT

In a method for sending messages to a plurality of recipients, for at least one first recipient in a non-empty set of first recipients of a message, a search is conducted in at least one directory for an address of a second recipient associated with said first recipient in said directory. If at least one address of a second recipient is found, the search result is supplemented to a set of second recipients before the message is submitted to recipients included in any set of recipients of said message.

### FIELD AND BACKGROUND OF THE INVENTION

The present invention relates generally to a system and method for sending messages. More specifically, the present invention relates to sending messages, e.g. e-mail messages, to a plurality of recipients.

In the context of modern enterprise communication, especially internal enterprise communication, it is a common situation that a message has to be submitted not only to one recipient (e.g. an employee) or to several recipients, but also to superiors of such recipients in the hierarchical organization of such an enterprise.

Similar situations arise in project organizations, in which people cooperate by executing well-defined functions, and in which these functions may require that a certain second person have to be informed whenever a certain first person will be informed. More generally, modern business leads to many situations, in which networks of participants—individuals or organizations—are defined, in which a message sent to a first participant should also be sent to one or more second participants that have been associated with that first participant as “to be also informed” participants in the sense of the considered network.

A simple way to meet such requirements is to manually add associated recipients to a list of recipients of a message. For example, a user may manually include an associated recipient as a recipient of a so-called carbon copy (“CC:”) in a list of carbon copy (“CC:”) recipients of many customary e-mail clients. This is frequently done in the daily work of most individuals today and this is at the same time a tedious, time consuming and error-prone process.

### SUMMARY OF THE INVENTION

The present invention solves the foregoing problems and deficiencies by providing a method for sending messages to a plurality of recipients and a corresponding system to use this method. In this method, for at least one first recipient in a non-empty set of first recipients of a message, a search is conducted in at least one directory for an address of a second recipient associated with said first recipient in said directory. If at least one address of a second recipient is found, the search result is supplemented to a set of second recipients before the message is submitted to recipients included in any set of recipients of said message.

The method according to the present invention therefore offers the advantage of using the most up to date information about associated participants that is available, as long as applicants of this method make sure, that directories which store these up to date data are included in the scope of the search. A further advantage of the present invention may be seen in the fact that any changes in the data of this information about associated participants only have to be stored once, i.e. e.g. in a central directory. As long as this central directory is used in the search of the present invention, any user of the method according to the present invention will benefit of any changed data stored there before the search started. In the example of an enterprise organization with a typical hierarchical structure of employees and superiors, the method according to the invention will always deliver the most recent results as long as the enterprise directory is kept up to date with recent changes in the organizational structure of the company. Since this may easily been done by a central institution, the method according to the invention bears significant advantages with respect to costs and reliability.

It is important to understand that the method according to the present invention constitutes a dynamic access to all relevant data. As a consequence, any changes in the directory or directories will immediately result in corresponding changes of the sets of recipients of messages that have been created or modified by the method according to the invention. This advantageous effect could not be produced by any kind of static rules that might be stored in e-mail clients or similar tools.

A further advantage of the present invention is related to the fact that directories may be applied several times in iteration. This way, complete chains of associated participants may be created to make sure that all recipients that ought to be informed about the contents of a certain message actually will be informed about these contents. For example, in an enterprise organization with the typical hierarchical structure, the directory will have the structure of a hierarchical tree or some equivalent structure. This tree structure may be searched iteratively several times up and down for associated participants of higher degrees to build chains of associations or associated participants.

A further advantage of the present invention emerges from the possibility to manually edit the resulting sets of recipients after the search for associated participants.

The user may in this case manually add further recipients —which he possibly associates in his mind—or delete some recipients that were supplemented as a result of the search, e.g. if he knows that there are reasons to exclude these recipients from the (final) list of actual recipients.

The present invention is subsequently described in greater detail in the following detailed description of the invention, the appended drawings and the attached claims.

### BRIEF DESCRIPTION OF THE DRAWINGS

FIG. 1 is a schematic representation of a method according to a preferred embodiment of the present invention.

FIG. 2 is a schematic representation of network of participants with typical associations defined among the participants according to a preferred embodiment of the present invention.

FIG. 3 is a schematic representation of a special kind of network of participants in the form of a hierarchical tree that may be used in connection with a preferred embodiment of the present invention.

FIG. 4 is a schematic representation of a system according to a preferred embodiment of the present invention.

### DETAILED DESCRIPTION OF THE INVENTION

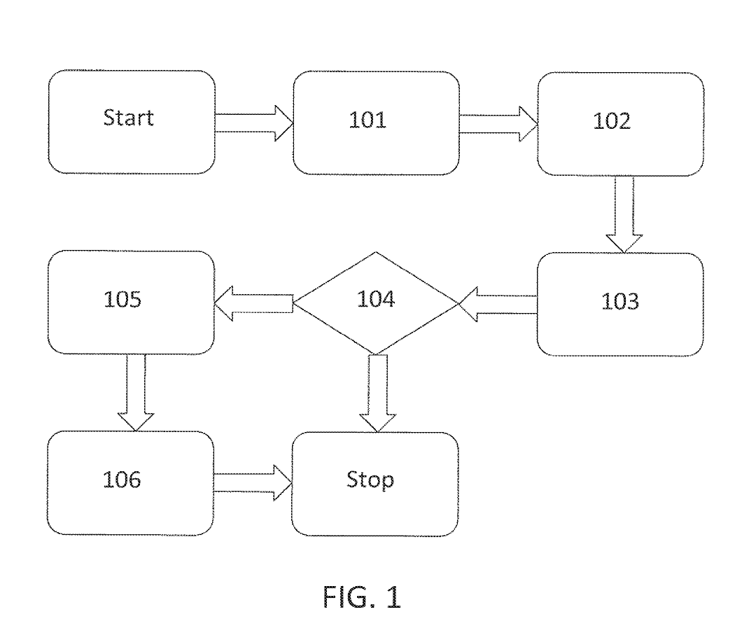

FIG. 1 shows a schematic representation of a method according to a preferred embodiment of the present invention. Imagine an individual, the sender, who wants to send a message, i.e. an e-mail or short message according to the well-known SMS service in (cellular) mobile phone networks or any similar kind of message, to at least one recipient. Usually the sender defines this at least one recipient by entering a suitable address of this recipient in a corresponding data field, usually designated by a symbol like “To:” or some similar symbol or icon, of the e-mail client or SMS client (usually a mobile phone) used by the sender. If the user now wants to use the currents invention, he or she initiates the start of a search 103 for associated recipients. Possibly, i.e., if the search shall not be conducted for all recipients entered by the user, before the search is started, the user selects 101 at least one first recipient, for whom or which the search 103 is to be conducted. If wanted or necessary, i.e. if a default directory is not defined or if other directories shall be included in the search, the user selects at least one (further) directory, which is the included 102 in the search 103.

If 104 the search 103 yields no results, the search stops at this point. The user may then manually add further first recipients and, if desired or necessary, start the search again, to possibly find second recipients associated with these recently entered first recipients.

If 104, however, the search yields at least one second recipient associated with some first recipient, this at least one second recipient will be supplemented 105 automatically to a set of second recipients, which usually will be a data field of the messaging client used by the user, which is usually designated by a symbol like “CC:” (abbreviation for carbon copy) or in a similar way. In some situations, the user may want to hide these second addressees, so that they remain invisible for other recipients. In this case, the user may elect to not supplement the second recipients to the “CC:”-list but to a similar list usually designated by a symbol like “BCC:” (abbreviation for blind carbon copy). This can be done by choosing a corresponding option before the search step, or by transferring the results after the search.

There may be cases, however, in which the user wants to additionally supplement 106 the search results also to the set (list) of first recipients, e.g. when the user wants to conduct a further search in which these search results, i.e. recently found second recipients, are now used as further first recipients. This can easily be done if the user activates a corresponding option in his e-mail client.

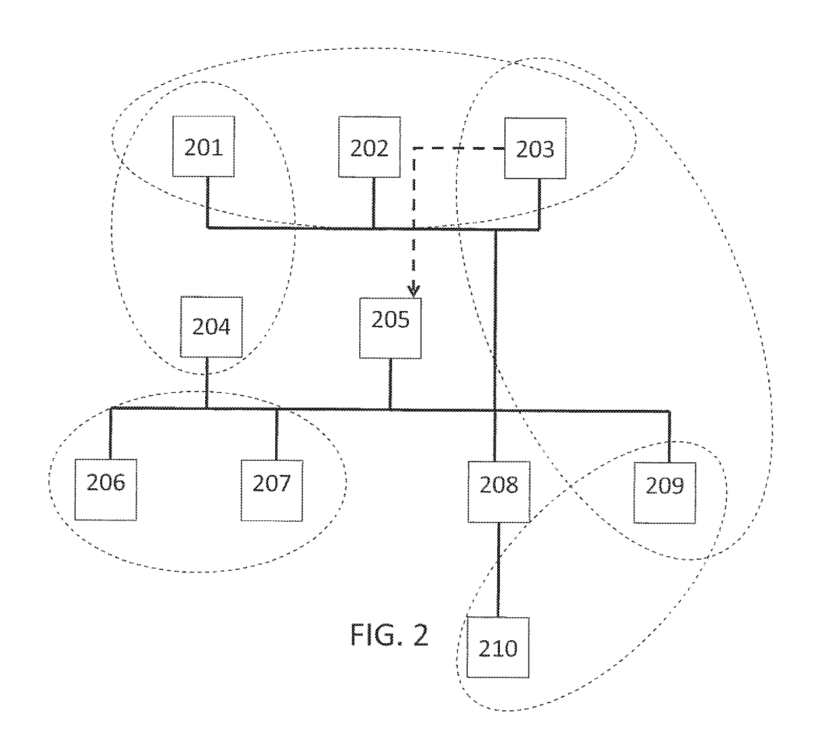

FIG. 2 shows a schematic representation of network of participants with typical associations defined among the participants according to a preferred embodiment of the present invention. This example of a network of participants 201, . . . , 210 does not exhibit any kind of “to be also informed” relation or association given by a hierarchical structure. Instead of such a hierarchy, two kinds of associations are shown in FIG. 2, namely a set-type association, defined by (sub-)sets or participants which have to be informed, i.e. included in the list of (second) recipients or a message, as soon as at least one participant in this (sub-)set is included in the list of recipients of this message. This kind of association rule is symmetric in the sense that as soon as any participant in the set defined by participants 201, 202, 203 is a recipient of a message send by any sender obeying the rule, all other participants in this set are to be included in the list of recipients. This is also true for other sets shown in FIG. 2, e.g. for the sets defined by 201 and 204, 206 and 207, 209 and 210 or 203, 209. Now imagine, participant 203 is entered into or supplemented to a list of recipients of a message. According to the rules displayed by FIG. 2, participants 102, 203 and 209 have to be supplemented to the list of recipients. But since participant 210 is in a set together with recipient 209, participant 210 has also to be supplemented to the list of recipients. A similar rationale is valid for participant 204. Moreover, a second kind of association rule, which is non-symmetric, demands that participant 205 also has to be a recipient of this message, because the rule demands that participant 205 has to be informed as soon as participant 203 is a recipient of a message, whereas the opposite is not intended by the rule.

It should be kept in mind in connection with the present invention that all participants may be individuals or organizations. The skilled reader will be easily able to further elaborate the invention into further embodiments, in which e.g. special rules for large organizations may be defined to make sure that the network used to submit a message would not break down because of an overload.

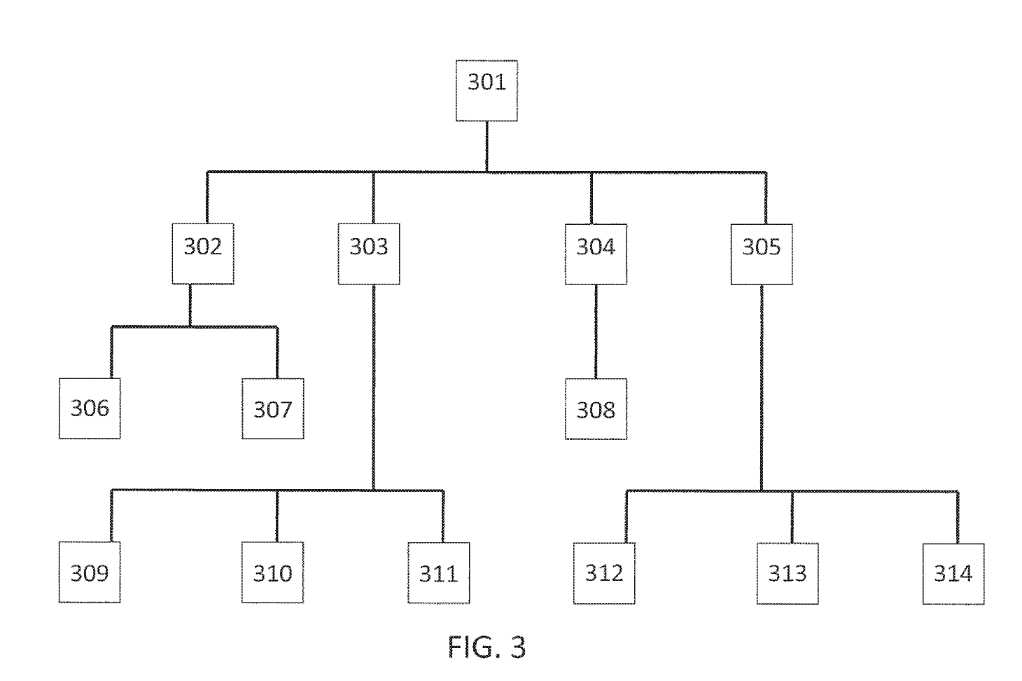

FIG. 3 is a schematic representation of a special kind of network of participants 301, . . . , 314 in the form of a hierarchical tree that may be used in connection with a preferred embodiment of the present invention. Whenever a hierarchy is defined for the members of a network of participants, the network can generally be displayed in the form of a hierarchical tree, as shown in FIG. 3. For example, participant 301 is superior to participants 302, . . . , 305, and participant 305, again, is superior to participants 312, 313 and 314. Usually, participants of a hierarchy are individuals but this is not necessarily so in any case. The so-called “leaves” 306, . . . , 308 and 309, . . . , 314 of a hierarchical tree may easily be imagined as “departments” or other (sub-)organizations of an enterprise. But also the root 301 may be a group of individuals, at least in a directory built for the purposes of the present invention.

At least two kinds of “to be also informed”-associations may be imagined in such a hierarchy: Either, inclusion of a superior, e.g. 305, as a (first) recipient in a list may imply or demand inclusion of all the nodes (in or example: 312, . . . , 314) below this recipient, or, as another type of rule, inclusion of one or all nodes, e.g. 306, 307 below a superior node 302 as a (first) recipient in a list may imply or demand inclusion of the superior node as a (second) recipient. Rules of this kind may differ by the number of levels to be included. If all levels are included, application of both rules after another will necessarily include the whole organization. If, however, the number of levels is restricted, iterative application of both rules (“up and down the hierarchy”) will yield subsets of the hierarchy depending on the needs of the user of the invention.

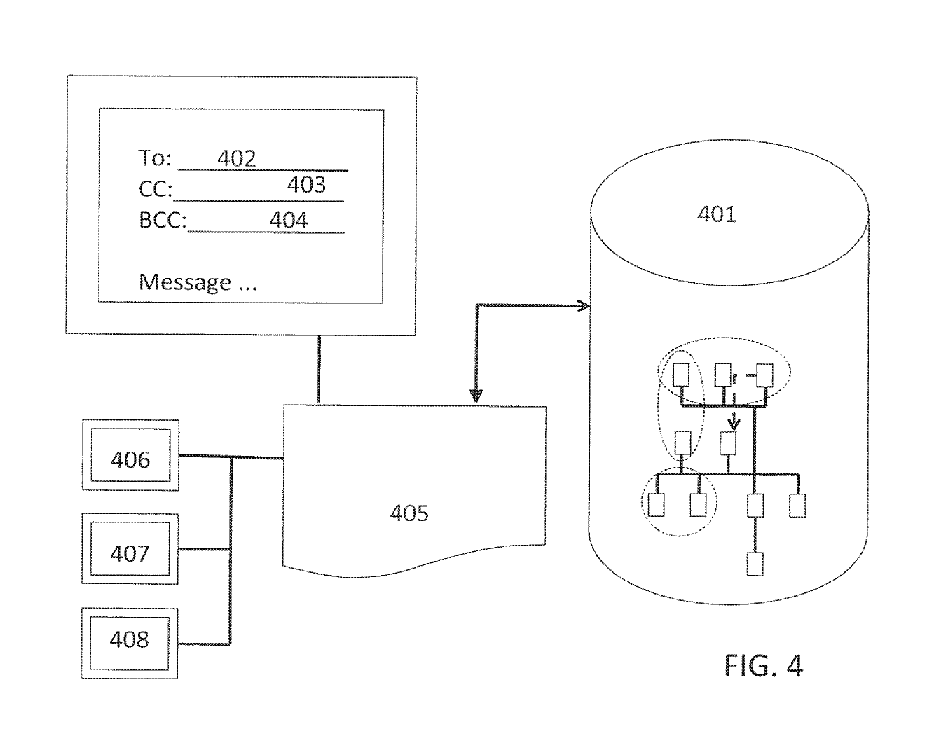

FIG. 4 is a schematic representation of a system according to a preferred embodiment of the present invention. Several user terminals 406, . . . , 408 or other kinds of messaging clients with means for creating, editing, processing and submitting messages to recipients at other user terminals are connected via a communication system, e.g. a LAN, WAN, WLAN or the internet, or any other kind of communication system.

The user terminals comprise storage means for storing at least one set of first recipients 402 and at least one set of second recipients 403, 404. The processing means 405 are equipped for conducting—for at least one first recipient in a non-empty set of first recipients of a message—a search in at least one directory 401 for an address of a second recipient associated with said first recipient in said directory.

The processing means 405 are equipped for supplementing the search result to a set of second recipients if at least one address of a second recipient is found. The message is then submitted to recipients included in any set of recipients of said message. The system may further comprise means for selecting at least one first recipient or a subset of first recipients 402 from said set of first recipients by a user of said system, for which selected first recipient or selected subset of first recipients said search will subsequently be conducted. In some situations, a system further comprising means for supplementing the search results also to said set of first recipients will be especially advantageous.

The system may further comprise means for editing at least one set of recipients by a user before submitting said message. This introduces the possibility to add recipients not found by the search or to delete certain recipients, which should not be included according to special information of the user about the current situation. The system may further comprise at least one searchable directory, which may e.g. be a hierarchically structured database of addresses of possible recipients of messages in a hierarchically structured organization as shown in FIG. 3.

The directory or directories to be searched may be considered as part of the inventive system or as being outside of the system but connected to the system via communication means. In any case, the association rules, i.e. rules that define who is to be associated with whom, will in most cases be stored in the directory or in one directory or some of these directories. They may, however, also be stored on separate servers. The present description of the invention has given several non-exhaustive examples for such associative networks or rules, and the skilled reader will be able to easily find extensions or elaborations of these examples.

1-10. (canceled)

11. A method for sending messages to a plurality of recipients, comprising the following steps:
selecting at least one first recipient for a message via a messaging client;
initiating a first search for all second recipients that are defined as being in association with the at least one first recipient via the messaging client;
determining that if the initiated first search identified second recipients associated with the at least one first recipient and adding the identified second recipients as a recipients to the message so that all the second recipients identified in the first search as being associated with the at least one first recipient are added as recipients to the message, and
initiating a second search for all third recipients that are defined as being in association with at least one of the second recipients via the messaging client;
determining that the initiated second search identified third recipients and adding the identified third recipients as a recipients to the message so that all third recipients identified in the second search are added as recipients to the message,
sending the message via the messaging client after the second and third recipients are added to the message; and
wherein the association between the at least one first recipient and the second recipients is defined in a first directory; and
wherein the association between the second recipients and the third recipients is defined by the first directory, the first directory identifying an organizational hierarchy that includes the first, the second, and the third recipients, each third recipient being superior to at least one of the second recipients and each second recipient being superior to the at least one first recipient.

12. The method recited in claim 11, wherein each third recipient is a recipient that is defined as being within a subset of recipients with at least one of the second recipients in the first directory.

13. The method recited in claim 11, wherein the first directory is a central corporate directory.

14. The method recited in claim 11, further comprising editing the recipients to the message by removing at least one of the second recipients and the at least one of the third recipients added to the message before the message is sent.

15. The method recited in claim 14 wherein the first directory is a hierarchically structured database of addresses of possible recipients of messages in a hierarchically structured organization.

16. A system for sending messages to a plurality of recipients, comprising:
a plurality of terminals, and
a communication system connected to the terminals, the system comprising a processing device and a directory, the directory identifying an organizational hierarchy that defines a first set of recipients as first recipients and a second set of recipients as second recipients, any of the second recipients being associated with all other second recipients in the hierarchy defined by the directory and any of the first recipients being associated with all other first recipients in the hierarchy defined by the directory; and
the processing device configured to conduct a first search of the directory for all other first recipients when at least one first recipient is identified as a recipient of a message to be sent by one of the terminals, the processing device configured to also conduct a second search of the directory for all other second recipients after at least one of the second recipients was added to the message as a recipient based on the first search; and
the processing device configured to add all the other first recipients found from the conducted first search as recipients to the message after the first search and add all other second recipients found from the conducted second search as recipients of the message after the conducted second search and after all the other first recipients were added to the message.

17. The system recited in claim 16, wherein the communication system is comprised of a LAN, WAN or WLAN.

18. The system recited in claim 16, wherein the processing device is configured so that editing of the message to be sent by the terminal occurs via input from a user of that terminal prior to the message being sent.

19. The system recited in claim 16, wherein at least one of the second recipients is a superior to other second recipients and at least one of the first recipients is a superior to other first recipients.

20. The system recited in claim 16, wherein the directory is comprised of a hierarchically structured database of addresses of possible recipients of messages in a hierarchically structured organization.

21. The method of claim 11 wherein the message is an e-mail or a short message according to an SMS service in mobile phone networks.

22. The system of claim 16 wherein the message is an e-mail or a short message according to an SMS service in mobile phone networks.

23. The system of claim 16 wherein the directory also defines a third set of recipients, any of the third recipients being associated with all other third recipients of the third set of recipients, and wherein the processing device is configured to conduct a third search of the directory for other third recipients when the message is addressed to at least one of the third recipients and is configured to add all the third recipients found from the conducted third search as recipients of the message.

24. A method for sending messages to a plurality of recipients comprising:
identifying a message having a first recipient identified as an addressee of a message to be transmitted via a messaging client;
initiating a first search for all second recipients that are defined as being in association with the first recipient in a directory via the messaging client, the directory identifying an organizational hierarchy;
adding all the second recipients as recipients to the message so that all the second recipients defined as being associated with the first recipient in the directory are recipients to the message,
initiating a second search for all third recipients that are defined as being a superior of any of the second recipients in the directory via the messaging client;
adding all the third recipients as recipients to the message so that all the third recipients defined as being associated as a superior to any of the second recipients in the directory are recipients to the message, and
sending the message via the messaging client after all the second and all the third recipients are added to the message.

25. The method of claim 24, wherein at least one superior of the first recipient is one of the second recipients.

26. The method of claim 24, wherein the message is an e-mail or a short message according to an SMS service in mobile phone networks.

27. The method of claim 26, wherein the directory is a hierarchically structured database of addresses of recipients of messages in a hierarchically structured organization.

28. The method of claim 26, wherein the messaging client is supported by a communication system.

29. The method of claim 26, wherein the messaging client is a terminal device that is connectable to a communication network and the message is sent via the network, the method further comprising:
conducting a third search of the directory for all fourth recipients that are defined as being in association with any of the third recipients in the directory via the messaging client; and
adding all the fourth recipients as recipients to the message so that all fourth recipients defined as being associated with at least one of the third recipients in the directory are recipients to the message.

30. The method of claim 26, wherein the directory is stored in a device that is accessible to the messaging client via a LAN, WAN or WLAN.
